(19) United States
(12) Patent Application Publication
(10) Pub. No.: US 2021/0238707 A1
(43) Pub. Date: Aug. 5, 2021

(54) APPARATUS FOR PRODUCING HOT BRIQUETTED IRON

(71) Applicant: JEIL MACHINERY CO., LTD., Gyeongsangbuk-do (KR)

(72) Inventor: Sang Kui PARK, Pohang-si (KR)

(73) Assignee: Jeil Machinery Co., Ltd., Gyeongsangbuk-do (KR)

(21) Appl. No.: 16/962,091

(22) PCT Filed: Sep. 2, 2019
(86) PCT No.: PCT/KR2019/011238

§ 371 Date: Jul. 14, 2020

(30) Foreign Application Priority Data
May 3, 2019 (KR) 10-2019-0051899

(51) Int. Cl. C22B 1/248; C22B 1/24

(52) U.S. Cl. CPC C22B 1/248; C21B 2400/044; C22B 1/2406

(57) ABSTRACT

A hot briquetted iron (HBI) production apparatus including a feeder unit, a quantitative dispenser unit, a hot briquette forming unit, and a cylindrical cooler, the feeder unit cooling and transporting direct reduced iron (DRI), the quantitative dispenser unit pulverizing the DRI and discharging a fixed amount of the DRI each time, the hot briquette forming unit forming hot iron briquettes by hot-pressing the DRI, the cooler unit cooling the hot iron briquettes, and including a cylindrical body with an inlet and an outlet, a transport screw or blade for transporting the hot iron briquettes, and a cooling water spray nozzle, the transport screw and the cooling water spray nozzle being disposed inside the cylindrical body, the hot iron briquettes being introduced into the cooler unit through the inlet and discharged from the cooler unit through the outlet, and cooling water being discharged from the cooler unit through the inlet.

### TECHNICAL FIELD

The present invention relates to an apparatus for producing hot briquetted iron (HBI). More particularly, the present invention relates to an apparatus for producing iron briquettes at a high temperature to prevent oxidation of direct reduced iron (DRI) discharged from a hot reduction furnace and to facilitate the transport of the DRI.

### BACKGROUND ART

Hot briquetted iron (HBI) is a product developed as a supplement for pig iron or scrap. It is produced by processing direct reduced iron (DRI) produced from direct reduction of iron ore. Since HBI is high quality iron, it is used as a material for manufacturing high quality steel products such as H-beams and steel plates.

DRI is prepared by heating a mixture containing an iron oxide-containing material and a carbonaceous reducing agent with a reduction furnace. In the furnace, iron oxides are reduced to metallic iron. Specifically, DRI can be prepared by reducing dried pellets made from magnetite ore and bituminous coal with a rotary hearth furnace, and HBI can be produced from hot forming of the DRI.

Direct reduction for preparing DRI refers to a process that reduces iron oxides (iron ore) in a high temperature environment of 1000° C. to 1200° C. When this hot DRI discharged from a hot reduction furnace is left at room temperature, there is a risk of fire because the hot DRI spontaneously ignites very easily. In this case, the DRI can slowly oxidize and return to its previous state (i.e., iron oxides). Therefore, there is room for improvement in a technique for cooling and storing hot briquetted iron (HBI) produced from hot pressing of direct reduced iron (DRI).

### DISCLOSURE

### Technical Problem

An objective of the present invention is to provide a HBI production apparatus for producing low-temperature iron briquettes from hot direct reduced iron (DRI) discharged from a reduction furnace so that the iron briquettes can be easily handled and carried.

The effects and advantages that can be achieved by the present invention are not limited to the ones mentioned above, and other effects and advantages which are not mentioned above but can be achieved by the present invention can be clearly understood by those skilled in the art from the following description.

### Technical Solution

In order to accomplish the objective, according to one aspect of the present invention, there is provided an apparatus for producing hot briquetted iron (HBI), the apparatus including: a feeder unit configured to cool and transport direct reduced iron (DRI); a quantitative dispenser unit configured to pulverize the direct reduced iron received from the feeder unit and discharge a fixed amount of the direct reduction iron each time; a hot briquette forming unit configured to form hot iron briquettes by processing the DRI discharged from the quantitative dispenser unit at high temperatures and high pressing forces; and a cylindrical cooler unit configured to cool the hot iron briquettes. The cooler unit includes a cylindrical body with an inlet and an outlet, a transport screw or blade for transporting the hot iron briquettes, and a cooling water spray nozzle. The transport screw and the cooling water spray nozzle are disposed inside the cylindrical body. The hot iron briquettes are introduced into the cooler unit through the inlet and are discharged from the cooler unit through the outlet, and cooling water is discharged from the cooler unit through the inlet.

In the cooler unit, the cooling water spray nozzle and the outlet may be positioned closer to each other.

The cooler unit may be obliquely installed such that the outlet is positioned higher than the inlet.

The cooler unit may include a sieve member in a discharge port of the outlet, the sieve member straining the hot iron briquettes to remove cooling water remaining on the surface of the hot iron briquettes.

The cooler unit may further include a rotating unit that rotates the cylindrical body.

The cooler unit may further include a blocking plate positioned close to the inlet, thereby maintaining a level of cooling water in the cylindrical body.

The hot briquette forming unit may include: a hot briquetting machine composed of briquetting rollers configured to hot-press the DRI at high temperatures to form hot briquetted iron and a hydraulic device that adjusts a pressing force of the briquetting rollers; and a separator that separates the hot briquetted iron discharged from the hot briquetting machine into the hot iron briquettes.

The quantitative dispenser unit may include: a pulverizer that pulverizes the DRI into DRI particles with a predetermined size; a storage bin that temporarily stores and discharges the DRI particles; and a diverter that switches between moving paths of the DRI particles discharged from the storage bin.

The feeder unit may include: a cooler that transports the DRI while performing indirect cooling on the DRI and a conveyer equipped with a bucket for transporting the cooled DRI.

### Advantageous Effects

According to one exemplary embodiment of the present invention, an apparatus for producing hot briquetted iron (HBI) is equipped with a cooler, thereby being capable of producing low-temperature iron briquettes by first preparing hot iron briquettes from direct reduced iron (DRI) that are discharged hot from a reduction furnace and then cooling the hot iron briquettes with the cooler unit.

### DESCRIPTION OF DRAWINGS

FIG. 1 is a schematic diagram illustrating a HBI production apparatus according to one embodiment of the present invention;

FIG. 2 is a perspective view illustrating a cooler unit of the HBI production apparatus according to one embodiment of the present invention;

FIG. 3 is a front-side perspective view illustrating the cooler unit of the HBI production apparatus according to one embodiment of the present invention, the apparatus being viewed from a direction of an outlet;

FIG. 4 is a cross-sectional view taken along a line A-A′ of FIG. 2; and

FIG. 5 includes a cross-sectional view taken along a line B-B′ of FIG. 2 and a plan view illustrating a driving gear.

### BEST MODE

Herein below, preferred embodiments of the invention will be described in detail with reference to the accompanying drawings. The following embodiments are provided as examples to sufficiently convey the spirit of the present invention to those skilled in the art. Accordingly, the present invention is not limited to the embodiments described below and may be embodied in other forms. In the drawings, the lengths and thicknesses of layers or regions may be exaggerated for convenience of illustration and clarity. Throughout the drawings and description of the embodiments, like components are designated by like reference numerals.

[symbol]

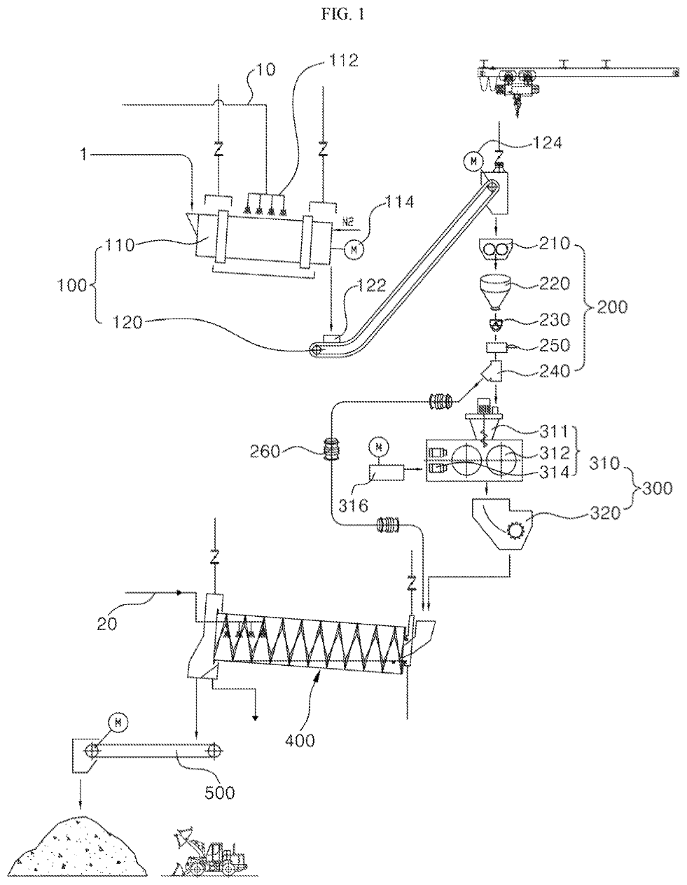

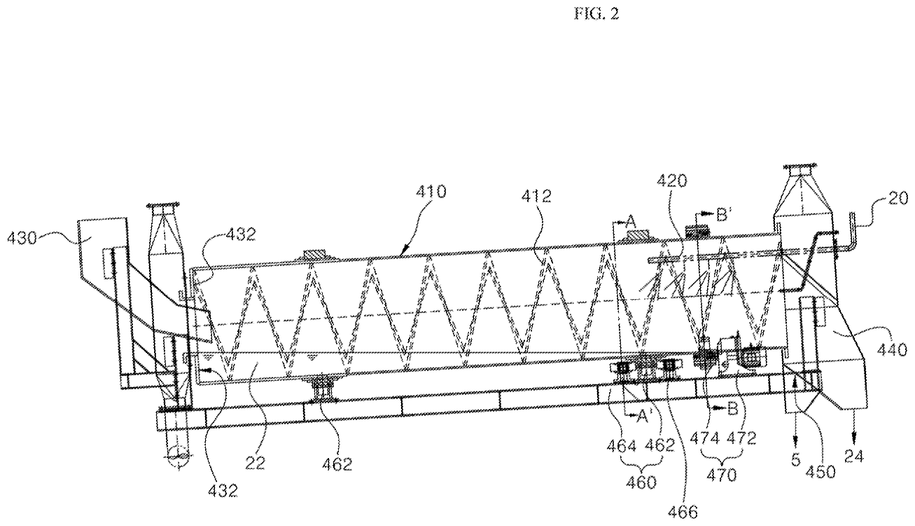

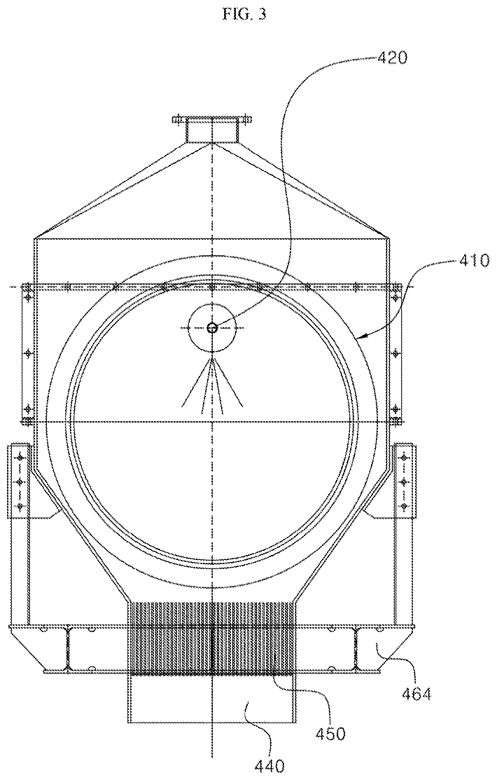

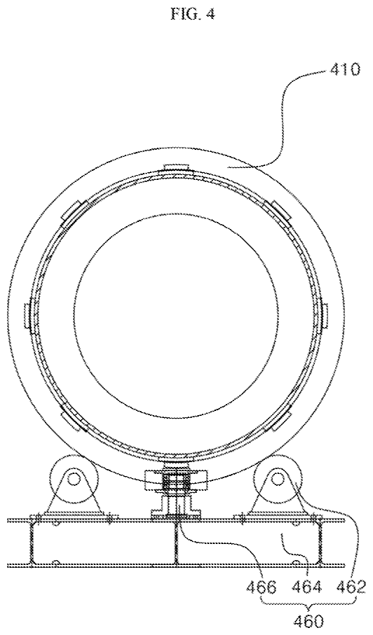

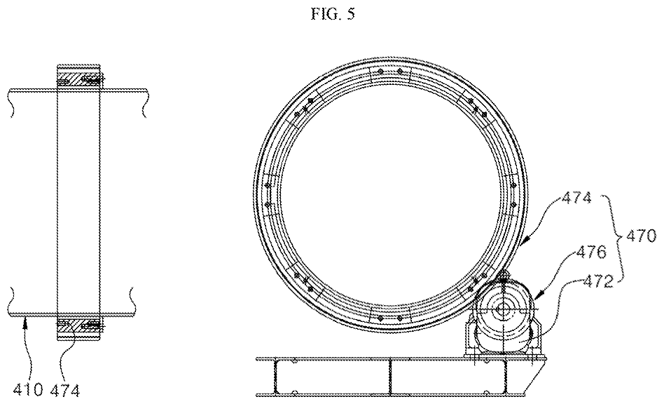

FIG. 1 is a schematic diagram illustrating a hot briquetted iron (HBI) production apparatus according to one embodiment of the present invention, FIG. 2 is a perspective view illustrating a cooler unit of the HBI production apparatus according to one embodiment of the present invention, FIG. 3 is a front-side perspective view illustrating the cooler unit of the HBI production apparatus according to one embodiment of the present invention, the apparatus being viewed from a direction of an outlet, FIG. 4 is a cross-sectional view taken along a line A-A′ of FIG. 2, and FIG. 5 is a cross-sectional view taken along a line B-B′ of FIG. 2.

Referring to FIGS. 1 to 5, the HBI production apparatus according to one embodiment of the present invention includes a feeder unit 100, a quantitative dispenser unit 200, a hot briquette forming unit 300, and a cooler unit 400.

[symbol]

The feeder unit 100 cools and transports direct reduced iron (DRI) 1. The feeder unit 100 includes a cooler 110 and a conveyer 120. Iron oxides are reduced at a high temperature of 1000° C. to 1200° C. to become the DRI 1. The DRI 1 is then transported to the feeder unit 100. In such a high temperature range, the DRI particles may aggregate with each other so that it is difficult to transport or transform the DRI particles. Therefore, the DRI 1 that is discharged hot needs to be cooled by the cooler 110. To minimize oxidation of the DRI, the DRI 1 is cooled through indirect cooling in a nitrogen atmosphere environment. For indirect cooling, the cooler 110 is equipped with cooling water nozzles 112 on the outer surface thereof. When cooling water is supplied to the cooler 110 through a cooling water pipe, the cooling water is sprayed outward from the cooler 110. The feeder unit 100 may further include a cooling water cover that prevents the cooling water from escaping to other units or components.

The cooler 110 performs indirect cooling on the DRI 1 and transports the DRI to the conveyer 120. The cooler 110 has a cylindrical main body which is connected to a motor 114. Thus, the main body of the cooler 110 is rotated by the motor 114.

To facilitate the transport of the DRI 1 to the conveyer 122 by using gravity, the cooler 110 is installed to be inclined toward the conveyer 120. In addition, the cooler 110 may further include a transport screw provided inside the main body. The transport screw rotates along with the main body of the cooler 110, thereby transporting the DRI 1.

The DRI cooled by the cooler 110 is transported to the conveyer 120. The conveyer 120 is equipped with a bucket 122 for the transport of the DRI and a motor 124 for moving the conveyer 120. For example, the conveyer 120 is a kind of chain conveyer. In this case, the bucket 122 is attached to a strand of chain that obliquely extends. The DRI is charged into the bucket 122 and then the bucket 122 moves down along the chain to the quantitative dispenser unit 200. The conveyer 120 may further include a guide member, a guide roller, a header chain roller, and a tail chain roller. While the DRI in the bucket 122 is being transported to the quantitative dispenser unit 200 by the conveyer 120, the DRI is further cooled down.

[symbol]

The DRI transported to the quantitative dispenser unit 200 is pulverized in the quantitative dispenser unit 200, and a predetermined fixed amount of the DRI is fed into the hot briquette forming unit 300.

Specifically, the quantitative dispenser unit 200 includes: a pulverizer 210 that pulverizes the DRI into DRI particles with a predetermined size; a storage bin 220 that temporarily stores and discharges the DRI particles; and a diverter 240 that switches between moving paths of the DRI particles discharged from the storage bin 220.

When iron ore (or iron oxides) particles are reduced in a direct reduction furnace, the particles are agglomerated. Therefore, the DRI discharged from the direct reduction furnace may be in the form of large masses or lumps. In the quantitative dispenser unit 200, the pulverizer 210 pulverizes the DRI masses or lumps into DRI pellets or fines which are than charged into the storage bin 220 having a predetermined volume. Therefore, a fixed amount of DRI can be discharged from the quantitative dispenser unit 200.

For example, the pulverizer 210 is composed of a pair of rollers each of which is provided with grooves or saw-like impact bars. The rollers are combined with respective rotary shafts spaced a predetermined distance from each other. When the large DRI masses or lumps pass between the pair of rollers, the large DRI masses or lumps are crushed into smaller DRI particles. Accordingly, the pulverizer 210 includes a pair of rollers, rotary shafts combined with the respective rollers, two motors connected to the respective rotary shafts, and a pulverizer casing encasing the other components. Since the pulverizer 210 cannot discharge a fixed amount of DRI particles, the storage bin 220 is used to a buffering space that temporarily stores a fixed amount of DRI particles and discharges it. The DRI particles are transported to the next stage process by a feed leg 260.

A shut-off valve 230 230 or a slide gate 250 may be provided between the storage bin 220 and the diverter 240 to control the discharge or the amount of discharge of the DRI particles.

The shut-off valve 230 is used to prevent the discharge of the direct reduced iron when the HBI production apparatus is inspected, repaired, or experiences unexpected malfunctioning during the production process. The shut-off value 230 is composed of a valve body and a valve actuator. In addition, the slide gate 250 is a mechanical device that can control the discharge amount of the direct reduced iron. The amount of direct reduced iron in the force feeder 311 of the hot briquette forming unit 300 is detected and the degree of opening of the slide gate 250 is correspondingly controlled. In this manner, it is possible to adjust the amount of direct reduced iron that is input to the hot briquette forming unit (300). For example, the slide gate 250 may be composed of a slide gate body, a gate, and a gate operating cylinder.

The diverter 240 for switching the moving paths of the direct reduced iron discharged from the storage bin 220 is a device that can change the direction of movement of the direct reduced iron between two paths. When forming hot briquetted iron (HBI), the diverter 240 guides the direct reduced iron to be transported toward the hot briquette forming unit 300. When discharging the direct reduced iron as it is, the diverter 240 guides the direct reduced iron to be transported toward a bypass line (not shown). That is, due to the presence of the diverter 240, it is possible to prepare for a situation in which the hot briquette forming unit 300 needs to be evacuated within a short time for some reasons, for example, in a case of an equipment failure or a certain emergency situation. The diverter 240 may be composed of a case, a damper, and a damper operating cylinder.

[symbol]

The direct reduced iron transported to the quantitative dispenser unit 200 is pressed at a high temperature through the hot briquette forming unit 300, thereby being molded into hot briquetted iron 5.

The hot briquette forming unit 300 may include a hot briquetting machine 310 and a separator 320.

The hot briquetting machine 310 includes a pair of briquetting rollers 312 that directly press the direct reduced iron and a hydraulic device 314 that adjusts the pressing force of the briquetting rollers 312. The direct reduced iron supplied by the operation of the screw located inside the force feeder 311 is passed through a nip between the briquetting rollers 312 rotating in counter directions. Thus, the direct reduced iron particles are changed into hot iron briquettes. For example, the briquetting rollers 312 may have a plurality of intaglio pockets, and the intaglio pockets may have a zigzag shape for higher molding efficiency. In addition to the hot briquetting machine 310, the force feeder 311, the briquetting rollers 312, and the hydraulic device 314, the HBI production apparatus may further include roller drive motors for rotating the briquetting rollers 312 and a reducer for adjusting the speed of rotation of the briquetting rollers 312, and a hydraulic cylinder and system 316 that adjusts the pressure of the hydraulic device.

The hot briquetted iron (HBI) produced through hot pressing of the hot briquetting machine 310 has a continuous strip shape. To separate the continuous strip-shaped hot briquetted iron into briquettes, the hot briquette forming unit 300 includes a separator 320. The separator 320 includes a guide frame, a rotor, a shaft, a casing, and a rotor drive motor. The briquettes discharged from the separator 320 are still hot (for example, a temperature of 550° C. to 650° C. Therefore, it is difficult to carry and handle the briquettes.

[symbol]

Therefore, the briquettes discharged from the hot briquette forming unit 300 are transported to the cooler unit 400 having a cylinder shape and are then cooled while passing through the cooler unit 400. The cooler unit 400 includes a cylindrical body 410 and a transport screw 412 or blade and a cooling water spray nozzle 420 which are provided in the cylindrical body 410. The body has an inlet 430 on a first side thereof and an outlet 440 on a second side thereof, in which the first side and the second side are opposite to each other. The briquettes can be introduced into the body through the inlet 430 and can be discharged from the body through the outlet 440. On the other hand, cooling water is discharged from the body through the inlet 430.

The cooler unit 400 may further include a device that rotates the body 410. The hot briquettes introduced into the body 410 through the inlet 430 are transported toward the outlet 440 by the transport screw 412 that rotates in conjunction with the body 410. The hot briquettes are cooled while being transported through the body 410, i.e., from the inlet to the outlet.

[symbol]

For effective transport and cooling of the hot iron briquettes, the rotary blades of the transport screw 412 are arranged at intervals of 3 to 10 times the width or size of the hot iron briquettes, and the height of the rotary blades is 1 to 1.5 times the width or the size of the hot iron briquettes.

[symbol]

In the cooler unit 400, the cooling water spray nozzle 420 is located in the vicinity of the outlet 440, and the cooling water moves to the cooling water spray nozzle 420 through the cooling water supply pipe 20. Since the cooler unit 400 is provided with the cooling water supply line 20 and the cooling water spray nozzle 420 located in the vicinity of the outlet 440, it is possible to directly spraying the cooling water onto the hot iron briquettes, thereby directly cooling the hot iron briquettes in the cylindrical body 410.

The cooler unit 400 is obliquely installed such that the outlet 440 is positioned higher than the inlet 430. In addition, a blocking plate is provided inside the body 410 and is positioned close to the inlet 430. Therefore, it is possible to maintain a level of cooling water 22 in the body 410. That is, the cylindrical body is inclined such that the inlet 430 through which the hot iron briquettes are introduced into the body is relatively low and the outlet 440 through which the hot iron briquettes cooled by the cooling water are discharged from the body. Therefore, cooling water 22 retained in the body and maintained at a predetermined water level primarily cools the hot iron briquettes introduced through the inlet 430, and cooling water sprayed from the cooling water spray nozzle 420 secondarily cools the hot iron briquettes that are primarily cooled by the retained cooling water and are then transported toward the outlet by the transport screw 412 or the blades. The hot iron briquettes are cooled in this manner by the cooler unit 400 and are then discharged from the cooler unit 400.

The blocking plate 432 positioned close to the inlet 430 is fixedly welded to the body 410. The blocking plate 432 acts like a dam for retaining the cooling water 22, thereby securing a constant level of the cooling water 22 retained in the body 410.

When the cooling water 22 is heated by heat-exchanging with the hot iron briquettes being present in the vicinity of the inlet 430, the water level rises and thus the heated cooling water overflows the blocking plate 432, thereby flowing out through the inlet 430. Since, cold cooling water is replenished, the temperature of the cooling water retained in the body is maintained below a predetermined temperature.

Therefore, the hot iron briquettes that are discharged hot (i.e. temperature of 550° C. to 650° C.) from the hot briquette forming unit 300 are cooled through direct contact with the cooling water or the rotary cooler unit 400. Thus, the hot iron briquettes are finally cooled to a temperature of 80° C. to 100° C. so that they can be easily carried and handled. That is, since the HBI production apparatus according to an embodiment of the present invention is equipped with the cooler unit 400, it is possible to produce low-temperature iron briquettes from direct reduced iron that is discharged hot from a direct reduction furnace. Thus, the produced iron briquettes can be easily transported to a destination by using a general-purpose transport facility.

The water level of the retention cooling water 22 is the same as the height of the blocking plate 432. For example, it may be 300 mm to 600 mm. The cooling water continuously supplied to the hot iron briquettes through the cooling water spray nozzle 420 overflows the blocking plate 432 and is thus discharged from the cooler unit 400 through the inlet 430. The cooling water that is discharged outside through the inlet is in a heated state. The heated cooling water flows into a cooling tower to be cooled again. This cooled cooling water is pumped by a cooling water circulation pump so as to be supplied again to the cooler unit 400 through the cooling water supply line 20 and the cooling water spray nozzle 420.

The contact time during which the cooling water sprayed from the cooling water spray nozzle 420 is in contact with the hot iron briquettes is about 5 to 10 minutes. On the other hand, the time of contact between the retention cooling water and the hot iron briquettes is determined depending on the temperature of the retention cooling water 22 in the body of the cooler unit. For example, when the temperature of the retention cooling water 22 is higher than a proper temperature, that is, when excessively many hot iron briquettes are supplied to the cooler unit, the feed flow rate of the retention cooling water 22 so that the retention time of the cooling water in the body 410 is decreased. Thus, cooling effect can be enhanced. On the contrary, when the temperature of the retention cooling water 22 is lower than the proper temperature, that is, when the supply amount of the hot iron briquettes is small, the feed flow rate of the retention cooling water 22 is reduced so that the retention time of the retention cooling water 22 in the body 410 is increased.

[symbol]

The inclination angle of the body 410 of the cooler unit 400 is in a range of 2° to 15°. The inclination angle is determined depending on the diameter and length of the body 410. When the diameter of the body 410 of the cooler unit is relatively large and the length is relatively short, the inclination angle is increased.

To support the inclined body 410, the cooling unit 400 includes a support 460 composed of a base frame 464, a support roller 462, and a guide roller 466. The support roller 462 provided between the base frame 464 and the body 410 supports the body 410 so that the rotational axis of the body does not shake during rotation of the body 410. The guide roller 466 prevents the linear movement of the body 410 in the backward-forward direction of the body 410. Therefore, although the body 410 of the cooler unit is inclined, the rotational motion of the body of the cooler unit can be stably performed due to the support 460.

In addition, the cooler unit 400 further includes a rotating unit 470 for rotating the body 410, and the rotating unit 470 takes a gear type or chain type driving mechanism. For example, in the case of a gear type, the rotating unit 470 includes a motor 472 that provides driving force, a pinion gear 476 mounted on the motor 472, and a driving gear 474 mounted on the outer surface of the body 410 and configured to engage with the pinion gear 476.

[symbol]

The cooler 400 may have a problem in that the internal temperature of the body 410 of the cooler unit 400 increases due to the vapor that occurs when the hot iron briquettes are cooled by the cooling water. In this case, it is difficult to cool the hot iron briquettes with the cooler unit 400. Therefore, the cooler unit 400 may further include a vapor discharge pump that pumps the vapor out of the body 410 of the cooler unit 400.

The cooler unit 400 may further include a sieve member 450 for separating the cooling water 24 and the hot iron briquettes 5 in a discharge port of the outlet 440. Due to the presence of the sieve member 450, the cooling water 24 remaining on the iron briquettes can be removed. That is, the cooled iron briquettes 5 are strained and then transported to a transporting device 500 and then stored in a storage tank.

[symbol]

Although the present invention has been described above with reference to the exemplary embodiment, it will be appreciated that those skilled in the art variously modify and change the present invention without departing from the spirit and scope of the present invention as set forth in the appended claims.

1. An apparatus for producing hot briquetted iron (HBI), the apparatus comprising:
a feeder unit configured to cool and transport direct reduced iron (DRI);
a quantitative dispenser unit configured to pulverize the DRI and discharge a predetermined fixed amount of the pulverized DRI at a time;
a hot briquette forming unit configured to hot-pressing the fixed amount of the DRI to form hot iron briquettes; and
a cooler unit configured to cool the hot iron briquettes,
wherein cooler unit comprises a cylindrical body with an inlet provided on a first side thereof and an outlet provided on a second side thereof, a cooling water spray nozzle provided inside the cylindrical body, and a transport screw or blade configured to transport the hot iron briquettes from the inlet to the outlet and provided in the cylindrical body, wherein the hot iron briquettes are introduced into the cooler unit through the inlet and are discharged from the cooler unit through the outlet, and cooling water retained in the body of the cooler unit is discharged outside through the inlet.

2. The apparatus according to claim 1, wherein the cooling water spray nozzle of the cooler unit is located in the vicinity of the outlet.

3. The apparatus according to claim 1, wherein the cooler unit is obliquely installed such that the outlet of the cooler unit is positioned other than the inlet.

4. The apparatus according to claim 1, wherein the cooler unit further comprises a sieve member disposed at a discharge port of the outlet to strain the hot iron briquettes so that the hot iron briquettes are discharged without the cooling water remaining on the surface of the briquettes.

5. The apparatus according to claim 1, wherein the cooler unit further comprises a rotating unit that rotates the body of the cooler unit.

6. The apparatus according to claim 1, wherein the cooler unit further comprises a blocking plate in the vicinity of the inlet, thereby maintaining a level of cooling water in the body.

7. The apparatus according to claim 1, wherein the hot briquette forming unit comprises: a hot briquetting machine including briquetting rollers that press the DRI at a high temperature to form hot briquetted iron and a hydraulic device that adjust a pressing force of the briquetting rollers; and a separator that separates the hot briquetted iron into the hot iron briquettes.

8. The apparatus according to claim 1, wherein the quantitative dispenser unit comprises: a pulverizer that pulverizes the DRI into DRI particles with a predetermined size; a storage bin that temporarily stores and discharges the DRI particles; and a diverter that switches between moving paths of the DRI particles discharged from the storage bin.

9. The apparatus according to claim 1, wherein the feeder unit comprises: a cooler that transports the DRI while performing indirect cooling on the DRI; and a conveyer equipped with a bucket that transports the cooled DRI stored therein.
